(19) United States
(12) Patent Application Publication
(10) Pub. No.: US 2001/0002597 A1
(43) Pub. Date: Jun. 7, 2001

(54) Fire department connection

(76) Inventors: Abdul Addo, Anaheim, CA (US); Ali Addo, Pomona, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/761,523

(22) Filed: Jan. 15, 2001

Related U.S. Application Data
(63) Continuation of application No. 09/709,673, filed on Nov. 9, 2000.
Application No. 09/709,673 is a continuation of application No. 09/648,901, filed on Aug. 25, 2000.
Application No. 09/648,901 is a continuation of application No. 09/222,724, filed on Dec. 29, 1998, now Pat. No. 6,173,739.
(60) Provisional application No. 60/084,677, filed on May 7, 1998.

(51) Int. Cl. F16K 15/03; A62C 35/00; F16L 5/00; F16K 15/00; F16K 17/00; F16K 21/04; B01D 1/00; E03B 3/18; E03B 7/07

(52) U.S. Cl. 137/512.1; 137/550; 137/360; 169/16

(57) ABSTRACT

A fire department connection (“FDC”) and a check valve in one. FDC saves labor and time when compared to the current FDC, because with current FDC, one has to install a check valve and then install the FDC. The new FDC is a one-step process. FDC is equipped with swivels which don't allow debris, garbage or trash to be deposited in the FDC and this makes FDC debris proof. FDC allows back flushing test to be performed by removing the cap and reversing the FDC. FDC comes with three different styles of outlets which are grooved, flange, and threaded. This gives the consumers more selections to suit their needs. Current FDC's come only with one style of outlet, which is threaded outlet.

### CROSS-REFERENCE TO RELATED APPLICATION(S)

This application is a continuation of application Ser. No. 09/709,673 filed Nov. 9, 2000, which is a continuation of application Ser. No. 09/648,901 filed Aug. 25, 2000, which is a continuation of application Ser. No. 09/222,724 filed on Dec. 29, 1998, which is a continuation of application Ser. No. 60/084,677 filed May 7, 1998.

### BACKGROUND OF THE INVENTION

The word “FDC” stands for fire department connection. FDC is a device located outside of buildings which are equipped with automatic fire sprinkler systems or standpipe systems or both standpipe and sprinkler systems for fire protection or fire fighting purposes. FDC allows the fire fighters to pump water into a standpipe system or a fire sprinkler system without going inside a building. In case of a fire in a building equipped with fire sprinkler system, the fire fighters will pump water through the FDC to help the fire sprinklers extinguish the fire with or without firefighters going inside the building.

All existing or current FDCs are installed with check valves which allow the water to flow in one direction only (in the system direction) and prevent any back flow of water. In other words, current FDCs depend on check valves in order not to let water to flow out of the sprinkler system and into outside of building.

### SUMMARY OF THE INVENTION

The present invention provides a fire department connection including two ends and a coupling for removable attachment to a building fire protection system. A first end of the fire department connection having one or more passenges for accommodating normal inflow. A second end of the fire department connection having a passage for accommodating normal outflow. A check valve is located in the outflow end. A removable filter or screener may also be located in the inflow passage to stop any debris or foreign material from entering or being deposited in the fire protection system. The end of the fire department connection coupled to the fire protection system may be grooved, flanged or threaded. Other features and advantages of the invention will become apparent from the following detailed description, taken in conjunction with the accompanying drawings, which illustrate, by way of example, the principles of the invention.

### BRIEF DESCRIPTION OF THE DRAWINGS

FIG. 1 is a side view of a straight FDC having two inlets and one outlet.

FIG. 2 is a side view of a 90° FDC having two inlets and one outlet.

FIG. 3 is a section view taken along line 3-3 of FIG. 2.

FIG. 4 is a section view taken along line 4-4 of FIG. 1.

FIG. 5 is a section view taken along line 5-5 of FIG. 2.

FIG. 6 is a side view of a filter.

FIG. 7 is a side view of a hinge pin.

FIG. 8 is a section view taken along line 8-8 of FIG. 1.

FIG. 9 is a section view taken along line 9-9 of FIG. 1.

FIG. 10 is a section view taken along line 10-10 of FIG. 2.

FIG. 11 is a side view of a straight FDC having two inlets and a flanged outlet.

### DETAILED DESCRIPTION OF THE INVENTION

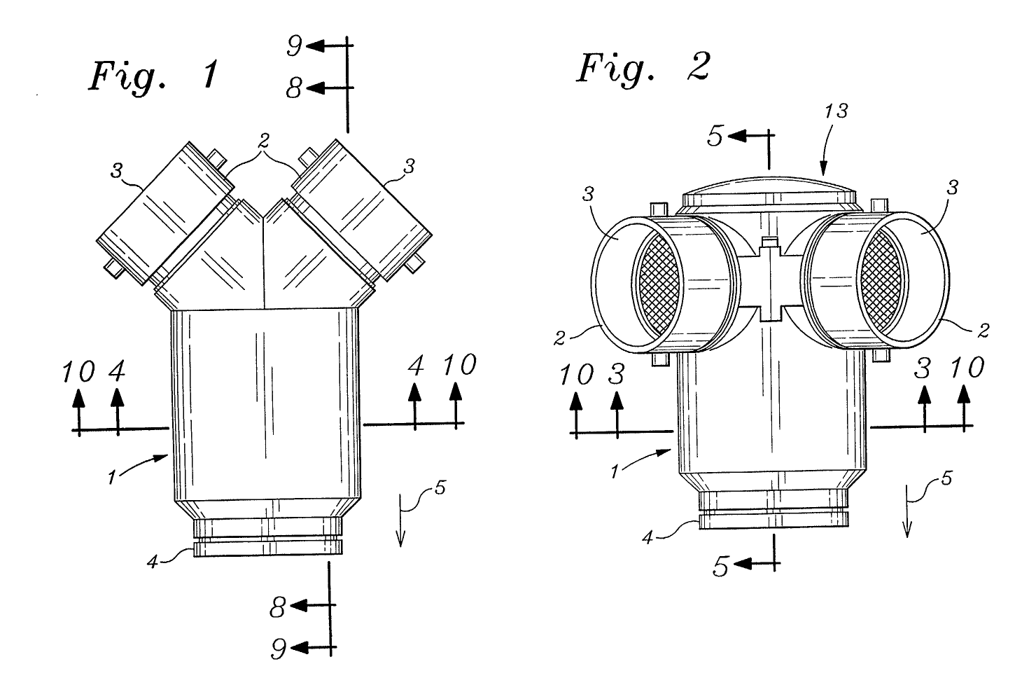

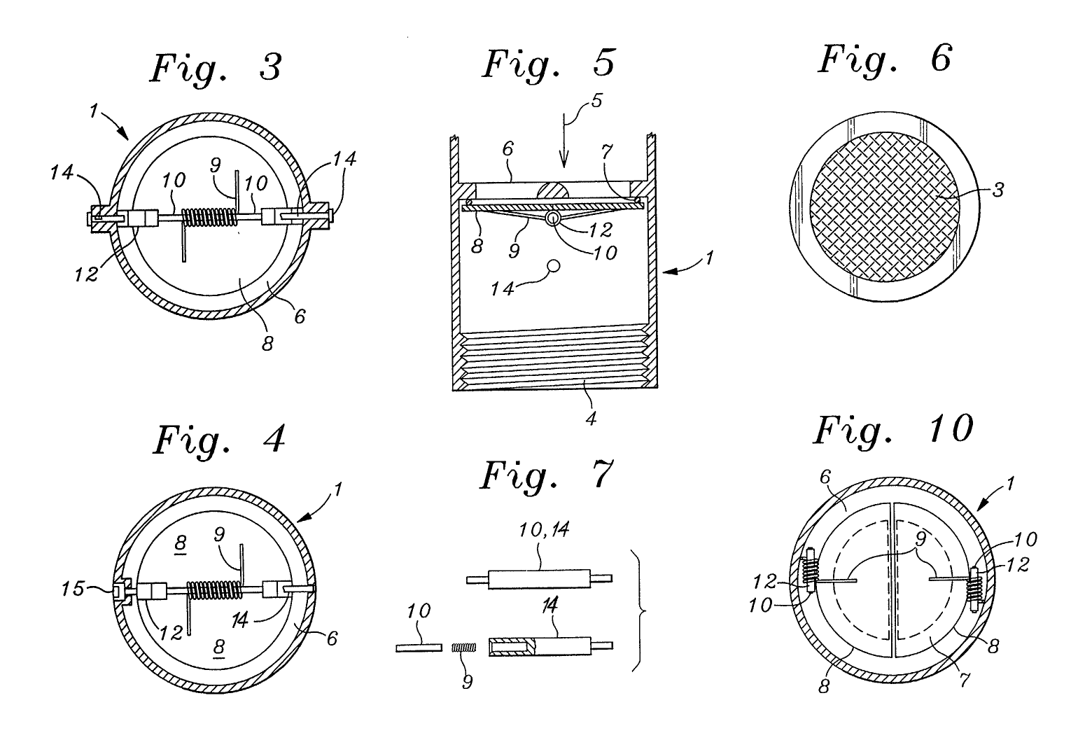

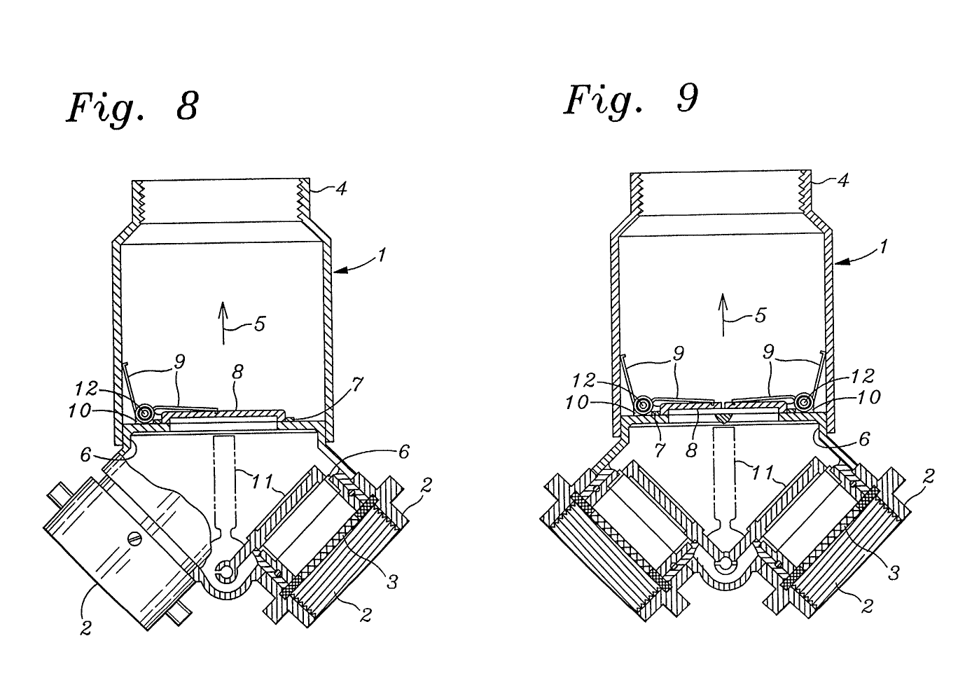

FDC of the present invention does not need a check valve, because it has a check valve built within. Please refer to FIGS. 3-5 and 8-10 and notations #8 & 9. These details show spring loaded clappers that allow the water to flow in one direction only. Please refer to FIGS. 1 and 2 and legend #2 (FDC inlet). In case of a fire, the fire fighters will pump water through the FDC inlet by using a public fire hydrant and their fire engine at a pressure of 100 psi and higher. When this process occurs, the spring-loaded clappers of FDC of the present invention open up or the clappers shall be pushed down by the bigger pressure of the fire engine and water flows through the FDC and into the fire sprinkler system. And as soon as the pumping of water is stopped, the clappers are pushed back to their original position by the spring. Therefore FDC of the present invention is capable of preventing water to flow from the fire sprinkler system to outside, while current FDCs depend on check valves to prevent the back flow of water.

Current FDCs have FDC inlets equipped with swivels, e.g., 2½inch swivels, which are female threaded and turn freely, allowing fire fighters to connect their fire hoses to the FDC so they may pump water into the fire sprinkler system. These swivels are equipped with either breakaway plastic or metal caps or male threaded metal caps. These caps are intended to keep garbage, trash or debris (which may cause water obstruction in case of a fire) out of the FDC. The caps are easily removable to avoid any delays to fire fighters pumping water into the fire sprinkler system in case of a fire. However these caps can't prevent garbage, trash or debris to get into the FDC because they can be broken or removed easily. There are some people out there who don't care or don't know the importance of FDCs, these people break FDC caps and deposit trash such as cigarette butts, beer bottles, soda cans, Styrofoam cups, etc. which are large enough to obstruct water flow into the fire sprinkler system. FDC of the present invention in comparison: please see FIGS. 2 and 3, legend notations #1, 2 and 3. FDC of the present invention shall have all the features of the current FDC, e.g., swivel breakaway caps. Since these features don't actually prevent garbage or trash to be deposited into the FDC, the swivel of the present invention is equipped with a water filter or water screener, such as a mesh or perforated screen, which doesn't allow garbage or trash to be deposited into the FDC and therefore allows the flow of water into the fire sprinkler system without any obstruction. Metallic (or other suitable material) mesh or screen may be used. The circumference of the mesh or screen may also be coated with rubber (or other similar material) . Preferably, the mesh or screen is removable to permit replacement.

The swivel of the present invention with a removable water screener or filter is a future hope for existing FDCs for preventing garbage or trash, which causes water flow obstruction, to get into the FDCs. All FDC swivels are removable and replaceable so FDC swivel of the present invention (or the filter or screen) can be manufactured separately and can be installed on any FDC in the USA.

Authorities having jurisdiction require all fire sprinkler systems to be tested and back flushed every one to five years. Back flushing means water flows out of the sprinkler system instead of going into the system, to get any debris or trash out of the system. All the fire sprinkler contractors perform this back flushing test by using the FDC, and it is done as follows: first they remove the check valve, then they reinstall the check valve reversed so water can be flushed from the system to outside through the check valve. After the back flushing is done, they remove the check valve again and reinstall them in the normal order. FDC of the present invention allows this back flushing test procedure by removing the cap (typically a 4″male threaded cap) (See FIG. 2, legend notation #13) and installing FDC in reverse. After the test is done, the FDC shall be installed in the normal manner with the cap screwed or otherwise connected back on the FDC. All current or existing FDCs come in many styles such as straight, 90 angle and 45 angle for the purpose of giving the consumers more options or flexibility of installation. But when it comes to FDC outlet, there is no choice because current FDCs come with female threaded outlets only.

FDC of the present invention comes with three different styles of outlets (please refer to FIGS. 1, 2, 8, 9 and 11 and legend/notations Nos. 4 & 13):

1. Grooved outlet (FIG. 2);

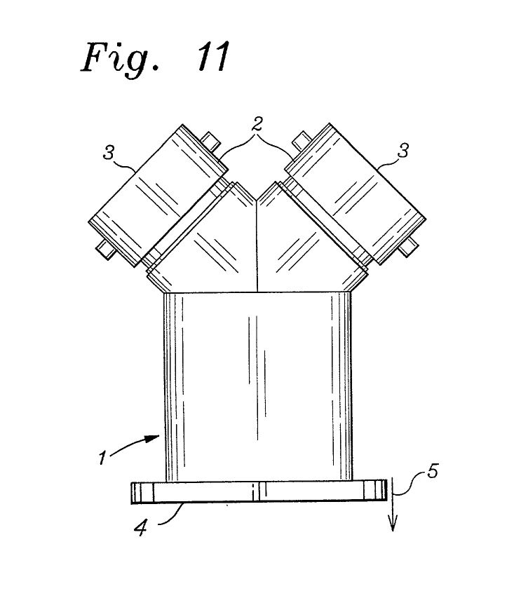

2. Flanged outlet (FIG. 11);

3. Threaded outlet (same as current FDCs).

Furthermore FDC of the present invention comes with all different styles, such as straight (FIG. 1), 90 angle (FIG. 2) & 45 angle FDC, same as current FDCs.

### Reference Numbers

1. FDC Body

2. Inlet with swivel

3. Water Filter or Screener (removable, retrofitable, optional)

4. Grooved/flanged/threaded outlet

5. Arrow Indicating Direction of flow

6. Clapper/Seat Seating

7. Gasket (0-Ring) for Sealant

8. Spring loaded Clapper

9. Spring

10. Hinge Pin

11. Freely swinging Clapper or Clappers

12. Hinge

13. Thread, Grooved or Flanged Cap (allows reverse flow)

14. Clapper Stopper Pin

15. ½″NPT Plug (for ball drip valve)

What is claimed is:

1. A reversible fire department connection comprising two axially opposite ends, each end being removably coupled to a pipe attachment of a building fire protection system, one end having one or more passages for accommodating normal in flow or out flow, and an axial passage closeable by a removable cap, a check valve located in the other end, in a first operative position of the fire department connection, water is supplied to the fire protection system, and in a second operative position of the fire department connection, water is drained from the fire protection system by removing the cap and connecting the axial passage end to the fire protection attachment.

2. The reversible fire department connection according to claim 1 wherein each end removably coupled to the fire protection system attachment is grooved.

3. The reversible fire department connection according to claim 1 wherein each end removably coupled to the fire protection system attachment is flanged.

4. The reversible fire department connection according to claim 1 wherein each end removably coupled to the fire protection system attachment is threaded.

5. A fire department connection comprising two opposite ends, one end being removably coupled to a pipe attachment of a building fire protection system, a first operative end of the fire department connection having one or more passages for accommodating normal in flow, and an opposite passage for accommodating normal out flow, a check valve located in the outflow end, in the first operative position water is supplied to the fire department connection, and the opposite end where the check valve is located, water is supplied to the fire protection system.

6. A fire department connection comprising two opposite ends, one end being removably coupled to a pipe attachment of a building fire protection system, a first operative end of the fire department connection having one or more passage for accommodating normal in flow, and an opposite passage for accommodating normal out flow, a check valve located in the outflow end, in the first operative position, water is supplied to the fire department connection, and the opposite end where the check valve is located water is supplied to the fire protection system, and a removable filter or screener for stopping any debris or foreign material from entering or being deposited in the fire protection system through the fire department connection located in one or more in flow passages.

7. The fire department connection according to claim 5 where one end removably coupled to the fire protection system attachment is grooved.

8. The fire department connection according to claim 6 where one end removably coupled to the fire protection system attachment is grooved.

9. The fire department connection according to claim 5 where one end removably coupled to the fire protection system attachment is flanged.

10. The fire department connection according to claim 6 where one end removably coupled to the fire protection system attachment is flanged.

11. The fire department connection according to claim 5 where one end removably coupled to the fire protection system attachment is threaded.

12. The fire department connection according to claim 6 where one end removably coupled to the fire protection system attachment is threaded.
